(19) United States
(12) Patent Application Publication
(10) Pub. No.: US 2025/0093018 A1
(43) Pub. Date: Mar. 20, 2025

(54) SECURITY LIGHT APPARATUS

(71) Applicant: James Michael Burry, Troutman, NC (US)

(72) Inventor: James Michael Burry, Troutman, NC (US)

(21) Appl. No.: 18/947,829

(22) Filed: Nov. 14, 2024

Related U.S. Application Data
(60) Provisional application No. 63/538,427, filed on Sep. 14, 2023.

(51) Int. Cl. F21V 21/30; F21V 23/04; F21V 23/06

(52) U.S. Cl. CPC F21V 21/30; F21V 23/0471; F21V 23/06

(57) ABSTRACT

A security lighting apparatus having a threaded contact post for electrically coupling, via screw-in installation, with a standard Edison-style socket, wherein the threaded post rotates independently relative to the remainder of the security lighting apparatus. As a result, during the installation the head component of the security lighting apparatus remains stationary relative to a previously established orientation so that proper positioning of the security lighting functionality is undisturbed during installation. A lock ring disposed between the threaded contact post and remainder of the security lighting apparatus moves between a locked engagement and an unlocked engagement enabling the independent rotation of the threaded contact post.

### CROSS REFERENCE TO RELATED APPLICATION

This application claims the benefit of priority of U.S. provisional application No. 63/538,427, filed 14 Sep. 2023 the contents of both are herein incorporated by reference.

### BACKGROUND OF THE INVENTION

The present invention relates to light fixtures and, more particularly, to an outdoor security light fixture that electrically connects to an existing standard threaded light socket by way of a threaded post, wherein the threaded post enables the relative orientation of the outdoor security light fixture to remain unchanged while the threaded post is screwed into the standard light socket.

Many homes have security light fixtures installed under the eave of the roof. This is a tight area that also often shares space with gutters and downspouts. Many of the existing security light sockets are designed to accept basic flood lights that screw into the existing socket with an Edison style lightbulb thread or Edison screw(ES). These types of fixtures and bulbs are not “smart”, meaning they do not have motion or light detection functionality. The current solutions to upgrade this type of lighting requires a homeowner to do electrical work by not only uninstalling their current security fixture and installing an entirely new lighting fixture, but further requires the homeowner to install an upgraded electrical socket to accommodate the electrical demands of the upgraded security fixture. Many homeowners are not comfortable with this type of electrical work because if done improperly results in, at best, an unusable electrical socket, or possibly starts an electrical fire. Furthermore, electrical fires resulting from unlicensed electrical work may not be covered by some home insurance policies.

In sum, current lighting upgrade solutions require the user to hire a licensed electrician to rewire their light fixtures or do potentially dangerous home wiring themselves, typically done ten or more feet up a ladder. Rewiring a home for new light fixtures is expensive if one uses a licensed electrician. Doing it oneself is a time-consuming job which is almost always done on a ladder, making the job itself dangerous irrespective of the electrical work.

Moreover, upgrading the existing fixtures with modern features is difficult in itself due to the requirement to spin the light fixture into the socket and the limited space under the roof eave to do that. Additionally, modern features on LED flood lights such as motion detectors, security cameras and large LED panels need proper orientation relative to the space and grounds they are surveilling, and so simply rotating them into a screw-in socket until it is tight does not ensure accurate final orientation, aim and placement since the modern features are rotating throughout the screw-in installation process and where they may be finally positioned up securing an electrical connection is difficult to ascertain beforehand.

As can be seen, there is a need for an outdoor security light fixture that screws into existing ES light sockets, wherein the modern features of the security light fixture are stationary during the screw-in process.

### SUMMARY OF THE INVENTION

The present invention solves the foresaid issues with a new and unique design allowing the user to screw a security lighting fixture into their existing standard lightbulb socket, whereby the security lighting fixture remains generally stationary as the rotational connection between the fixture and socket is formed, thereby converting a standard light fixture an upgraded security lighting fixture while not having to worry about the final positioning of the security lighting fixture during the installation process. The new lighting system can have modern lighting technology such as motion detection, light detection, security cameras, and large LED heads, yet still screw into the existing standard lightbulb socket with an Edison style thread in the standard screw-in manner, thereby enabling a sufficient electrical connection within confined spaces, such as under a tight eave spacing.

The present invention allows the user to upgrade their current security flood light fixture to modern lighting technology without rewiring a new lighting socket.

The solution embodied in the present invention allows users with existing light fixtures to quickly remove said existing light fixture and easily install an advanced security lighting fixture in the same socket, in a way that is as easy as “screwing in a light bulb”, with the users not having to worry about the proper orientation of the modern security features being upended by the installation process.

In one aspect of the present invention, a security lighting apparatus provides a head component for housing security components; and a threaded contact post operatively associated with the head component so that the threaded contact post rotates independently relative to the head component while providing an electrical connection therebetween, whereby the head component is stationary during screw-in installation of the threaded contact post to an Edison-style socket.

In another aspect of the present invention, the security lighting apparatus further provides: a rotational lock ring between the threaded contact post and the head component, wherein the rotational lock ring selectively moves between an unlocked engagement and a locked engagement preventing rotation of the threaded contact post relative to the head component; a housing directly interconnecting the head component and the threaded contact post, wherein a direct connection between the threaded contact post and the housing defines a rotatable connection, wherein the threaded contact post has a tapered circumference; threading along an external surface of the tapered circumference, wherein the threading is dimensioned and shaped to mesh with an Edison-style socket; and a distal end having an electrical contact configured to form an electrical connection with the Edison-style socket, wherein the threaded contact post rotates along a longitudinal axis shared by the threaded contact post, the housing, and the head component, wherein the threaded contact post, the housing, and the head component are coaxial, wherein the head component comprises a motion sensor, and wherein the motion sensor requires a predetermined orientation relative to a surveillance space.

These and other features, aspects and advantages of the present invention will become better understood with reference to the following drawings, description and claims.

### BRIEF DESCRIPTION OF THE DRAWINGS

FIG. 1 is a bottom-front perspective view of an exemplary embodiment of the present invention, shown in use.

FIG. 2 is a top-rear perspective view of an exemplary embodiment of the present invention.

FIG. 3 is an exploded perspective view of an exemplary embodiment of the present invention.

FIG. 4 is a bottom plan view of an exemplary embodiment of the present invention.

FIG. 5 is a detailed perspective view of an exemplary embodiment of the present invention, illustrating a screw-in installation between the novel security fixture 100 and an existing Edison-style socket 70.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an outdoor security light apparatus 100 integrated with modern security features that is adapted to screw into an existing Edison-style light socket whereby the modern security features remain stationary during the installation process.

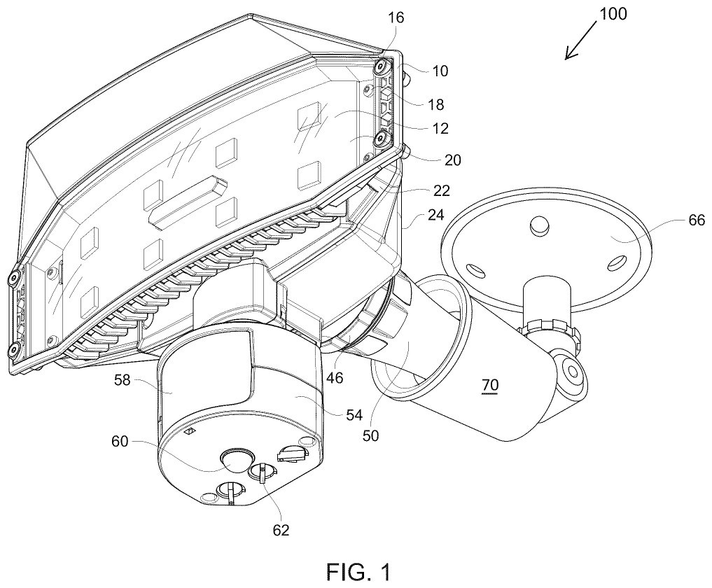

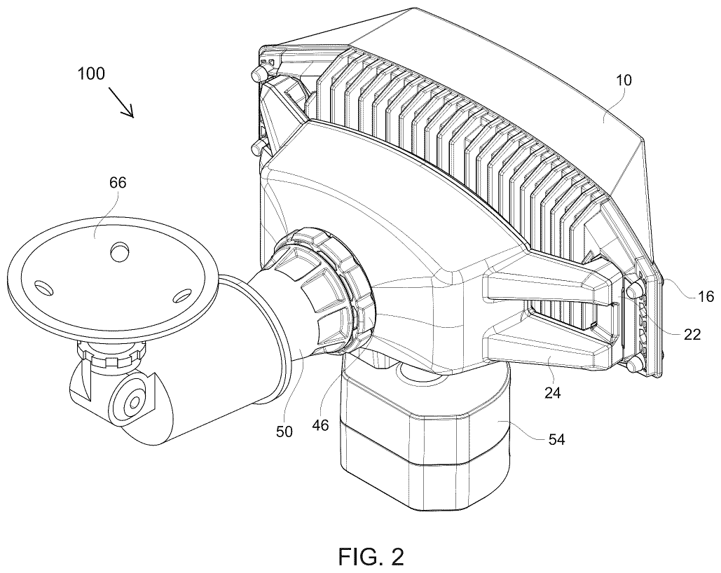

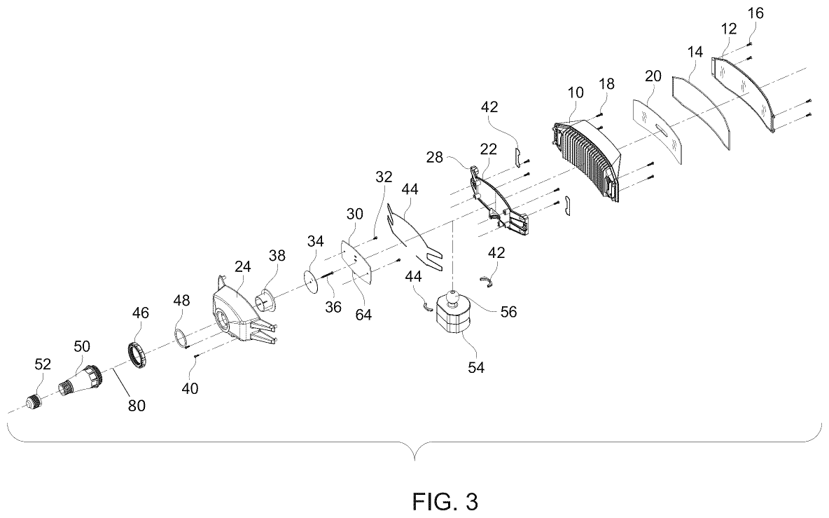

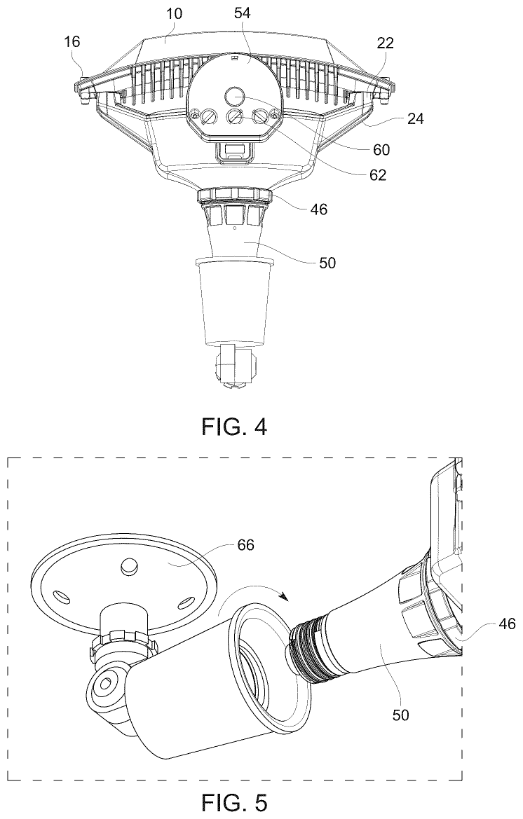

Referring to FIGS. 1 through 5, the present invention provides a security lighting fixture system and installation method embodied in a security light apparatus 100. The security light apparatus 100 has a body operatively associated with threaded contact post 50 by way a lock ring 46 so that the threaded contact post 50 rotates independent of the body, which supports security features requiring precise orientation when the security light apparatus 100 is secured in its final disposition.

The body of the security light apparatus 100 supports a lighting head where electrical security components and the light source(s) are housed. The light source(s) may be light emitting diodes (LEDs) behind a LED panel 20 and lens 12 of the lighting head. The electrical security components include but are not limited to a motion sensor 54 having an operatively associated ball connector 56, front lens 58, and bottom lens 60 as well as selectively orientation functionality by way of adjustable dials 62 adjacent thereto.

The body of the security light apparatus 100 may provide a lens frame 10 for supporting a lens 12 by way of a lens gasket 14 and fasteners 16 and 18. Along the rear of the light body may be a housing for one or more PCBs 30 and 34 that control the electronic and electrical functionality of the novel security light apparatus 100 and receive electrical signals through a USB port 64. The housing may have a first section 24 and a second section 22 engaging a housing section gasket 28. The PCBs 30 and 34 may be retained within the housing, along with a mounting body 38 by way of fasteners 32 and 36, respectively. The housing may also provide neck gaskets 42 and 44 as well as fasteners 40 for forming an adaptable attachment. The first section 24, along a rear surface of the housing/body may support a lock ring 46 and O-ring 48 that operatively associate with a threaded post 50 so that the threaded post 50 rotates independently of the remaining portion of the outdoor security light apparatus 100. A distal end of the threaded post 50 provides a threaded base contact 22 that electrically connects into an Edison-style threaded socket 70.

The body of the security light apparatus 100 may provide one or several articulating elements so that the user could selectively adjust the security and lighting elements relative to a supporting surface and lamp-holder 66 (supporting the Edison-style lightbulb socket 70) for independently aiming and orienting the light sources.

The lock ring 46 may be a threaded ring that enables tightening and loosening of the threaded post 50 into and out of the ES lightbulb socket 70 without rotating the systemic lighting head of the security light apparatus 100. The lock ring 46 may have a series of teeth formed on or otherwise provided on the annular rib. A switch may be provided along the lock ring, wherein the switch can be brought into meshing engagement with the teeth of the rotation lock ring, thereby preventing the threaded contact post 50 from rotating with respect to the body of the security light apparatus 100.

The ES threaded end of post 50 (like a typical lightbulb threaded contact/foot) is what screws into the existing ES lightbulb socket 70 used for the previous light fixture, just like a light bulb. What makes this unique is that the tail end of the security light apparatus 100 provides the ES contact end 52 independently spins relative to the systemic lighting head or body of the security light apparatus 100, whereby the lock ring 46 is used to tighten the systemic lighting head in place once the ES threaded post 50 is tightened into the existing ES lightbulb socket 70.

The lock ring 46 is movable between a locked engagement and an unlocked engagement with the threaded post 50. In the unlocked engagement, the threaded post rotates independently of the lighting elements of the apparatus 100, while in the locked engagement, the threaded post cannot rotate and is fixed relative to the apparatus 100. The ES threaded post 50 rotates about a longitudinal axis 80 in part because of the connection of the lock ring 46 and the second section 24 of the housing, at the interface of both a rotatable connection between the two are facilitated.

The independent motion detection head is a separate element enabling a user to aim it independently of the systemic lighting head. The independent motion detection head detects motion and sunlight.

Security lighting features work best when orientated properly in relation to each other and aimed properly at the user's yard or space wherein motion and activity are desired to be detected. Since traditional style light fixtures require a screw-in light socket providing a more sophisticated security and lighting functionality that screws into such Edisons-style sockets by itself would still have disadvantages not easily controlling the final orientation and disposition of the security and lighting functionality because of the rotational installation, which in turn would be problematic as many security lighting fixtures find themselves tucked into tight places, like under eaves. These disadvantages are overcome, however, with the present invention that allows the ES threading to rotate and screw into the ES light socket independently of the rest of the lighting and security apparatus.

To use the present invention, a user simply holds the systemic lighting head/body in place within a confined space (e.g., the roof eave), and with the lock ring 46 in an unlocked engagement the user manually rotates the ES threaded post 50 into the existing light socket 70. When the threaded post 50 is tightly secured in the socket 70, the user then tightens the lock ring 46 to the locked engagement, preventing the systemic lighting head from rotating or moving. As a result, system embodied by the present invention easily allows anyone to screw a large modern lighting system into a tight roof eave, even when gutter downspouts and other obstacles are in the way, thereby facilitating properly positioning and aiming large LED heads and other features such as motion sensors and security cameras.

The systemic lighting head and motion sensor can be designed in almost any shape and can be made from aluminum, plastic, or many other materials. It will house the LEDs and could also contain the PCB's required to power the LED. The key feature is the relationship between the main systemic lighting head and the ES threading. This is an electrical connection. It must be able to freely rotate, never bind any wires, and always maintain a good electrical connection with the systemic lighting head. The lock ring then rotates by using the ES threads to lock the rotation between the systemic lighting head and the ES threads. All these parts could be molded plastic, aluminum, or any other suitable material.

The necessary element is the independent rotational connection between the ES threads and the rest of the LED lighting system. This allows the larger part of the systemic lighting head to fit into tight spaces and be orientated properly while still being screwed into the existing lighting fixture. The systemic lighting head could or could not contain motion sensors, light sensors, security cameras, etc.

One could design the systemic lighting head and body in any shape. It could incorporate any additional features. Those features and the systemic lighting head could all be incorporated into one main body, or independent bodies which could be aimed individually.

The present invention is focused on the way a user may rotate the systemic lighting head into an existing lighting fixture with an ES lightbulb socket, while keeping the components of the lighting system in the proper orientation while the light is screwed into the preexisting socket.

The present invention enables a user to hold the lighting system in the proper orientation in one hand while screwing the ES threading into the existing light socket with the other hand. Once the light bulb style thread is tight in the socket, tighten the lock ring to prevent the light fixture from spinning.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A security lighting apparatus comprising:
a head component for housing security components; and
a threaded contact post operatively associated with the head component so that the threaded contact post rotates independently relative to the head component while providing an electrical connection therebetween,
whereby the head component is stationary during screw-in installation of the threaded contact post to an Edison-style socket.

2. The security lighting apparatus of claim 1, further comprising a rotational lock ring between the threaded contact post and the head component, wherein the rotational lock ring selectively moves between an unlocked engagement and a locked engagement preventing rotation of the threaded contact post relative to the head component.

3. The security lighting apparatus of claim 2, further comprising a housing directly interconnecting the head component and the threaded contact post, wherein a direct connection between the threaded contact post and the housing defines a rotatable connection.

4. The security lighting apparatus of claim 3, wherein the threaded contact post comprises:
a tapered circumference;
threading along an external surface of the tapered circumference, wherein the threading is dimensioned and shaped to mesh with an Edison-style socket; and
a distal end having an electrical contact configured to form an electrical connection with the Edison-style socket.

5. The security lighting apparatus of claim 4, wherein the threaded contact post rotates along a longitudinal axis shared by the threaded contact post, the housing, and the head component.

6. The security lighting apparatus of claim 5, wherein the threaded contact post, the housing, and the head component are coaxial.

7. The security lighting apparatus of claim 5, wherein the head component comprises a motion sensor.

8. The security lighting apparatus of claim 7, wherein the motion sensor requires a predetermined orientation relative to a surveillance space.
